(19) United States
(12) Patent Application Publication
(10) Pub. No.: US 2009/0059901 A1
(43) Pub. Date: Mar. 5, 2009

(54) VOIP network phone forwarding device and application thereof

(76) Inventors: Ping-Kun Wei, Hsinchu (TW); Chih-Jen Lu, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/153,288

(22) Filed: May 16, 2008

(30) Foreign Application Priority Data
Aug. 31, 2007 (TW) 096132388

(51) Int. Cl. H04L 12/66

(52) U.S. Cl. 370/352

(57) ABSTRACT

A VOIP network phone forwarding device is used to forward a call of an extension to a dual-mode mobile terminal. The VOIP network phone forwarding device comprises a wireless network module, a network interface, a phone connection interface, and a processor. The wireless network module connects to a wireless network for signal transmission with the dual-mode mobile terminal via the wireless network. The network interface is coupled to a modem device for connecting to the Internet. The phone connection interface is coupled to a PBX, which is further coupled to several extensions. The processor is coupled to all the above components. When a dialing source dials a phone call to an extension, the processor forwards this call to the dual-mode mobile terminal via the wireless network or the Internet so that a user can answer this call. A mobile extension communication architecture can thus be realized to let users be able to answer any phone call anytime, anywhere.

### BACKGROUND OF THE INVENTION

1. Field of the Invention

The present invention relates to a VOIP network phone technology and, more particularly, to a VOIP network phone forwarding device and the application thereof.

2. Description of Related Art

Because voice signals are compressed into data packets in Voice over Internet Protocol (VOIP) and transmitted via the Internet or IP data networks instead of conventional public switched telephone networks (PSTN), a large amount of communication expenses can be saved. There are two common modes for installing VOIP network phones. One is connecting conventional private branch exchange (PBX) to an external VOIP gateway, which is also connected to a modem (e.g., an XDSL modem or a cable modem) for connecting to the network. The other is directly replacing conventional PBX with IP PBX collocated with IP phone or softphone for network phone communication.

Although the function of IP PBX is more powerful than conventional PBX, its price is higher than VOIP gateway. Therefore, completely replacing conventional PBX with IP PBX will consume much capital. Moreover, when adopting IP PBX, if the network connection is broken, voice communication cannot be achieved in addition that there is no Internet access. Furthermore, in order to enhance the competitiveness, many enterprises do their best to avoid missing any phone call. However, it is difficult for the above two VOIP equipments and the peripherals thereof to accomplish the effects of no missed phone call and no lost information.

Accordingly, the present invention aims to propose a novel VOIP network phone forwarding device and the application thereof so as to solve the above drawbacks in the prior art.

### SUMMARY OF THE INVENTION

An object of the present invention is to provide a VOIP network phone forwarding device, which can be coupled to conventional PBX, and can also coupled to a modem device for connecting to the Internet, and has also a built-in wireless network module to connect to a wireless network. This VOIP network phone forwarding device can also match a dual-mode mobile terminal. When a user is not at the vicinity of an extension and cannot answer a phone call, the VOIP network phone forwarding device can forward this phone call to the dual-mode mobile terminal via the wireless network or the Internet, thereby accomplishing the effect of no missed phone call and no lost information. Moreover, it is not necessary to replace conventional PBX with expensive IP PBX, hence reducing the waste of capital.

Another object of the present invention is to provide an automatic call-forwarding communication system, which makes use of conventional PBX, VOIP network phone forwarding device, modem device and dual-mode mobile terminal having GSM and WiFi functions to realize a mobile extension architecture.

Yet another object of the present invention is to provide an automatic call-forwarding method, in which the VOIP network phone forwarding device is used to automatically forward a phone call of a desktop extension to a dual-mode mobile terminal via a wireless network or the Internet so that the user can answer the phone call.

To achieve the above objects, the present invention provides a VOIP network phone forwarding device, which is used to forward a phone call of at least one extension to at least one dual-mode mobile terminal. The dual-mode mobile terminal is not only a GSM mobile terminal, but also has a built-in WiFi module to connect to a wireless network. The VOIP network phone forwarding device comprises a wireless network module, a network interface, a phone connection interface, a processor and a power unit. The wireless network module is connected to the wireless network for signal transmission with the dual-mode mobile terminal. The network interface is coupled to at least one modem device to connect to the Internet. The phone connection interface is coupled to at least one PBX that is coupled to the extension. The processor is coupled to the wireless network module, the network interface and the phone connection interface, and forwards a phone call to the dual-mode mobile terminal so that a user can answer the phone call when a dialing source dials the phone call to the extension. The power unit provides electric power for all the above components.

Therefore, utilizing the VOIP network phone forwarding device of the present invention can realize an automatic call-forwarding communication system so that a user is no longer limited by desktop extension. In an environment with a wireless network or the Internet, a phone call can be forwarded to a dual-mode mobile terminal via the VOIP network phone forwarding device.

The present invention also provides an automatic call-forwarding method, which comprises the steps of: coupling a VOIP network phone forwarding device to at least one PBX coupled to at least one extension; connecting the VOIP network phone forwarding device to a wireless network, and coupling the VOIP network phone forwarding device to at least one modem device to connect to the Internet; providing at least one dual-mode mobile terminal capable of connecting to the wireless network for signal transmission with the VOIP network phone forwarding device in a hot-spot environment and then registering to the VOIP network phone forwarding device to become an extended extension of the extension; and using the VOIP network phone forwarding device to forward a phone call to the dual-mode mobile terminal via the wireless network or the Internet so that a user can answer the phone call when a dialing source dials the phone call to the extension. When a dialing source dials a phone call to an extension and there is no one answering this phone call, or a user presses a call-forwarding button on the VOIP network phone forwarding device in advance, the VOIP network phone forwarding device will forward this phone call to the dual-mode mobile terminal.

### BRIEF DESCRIPTION OF THE DRAWINGS

The various objects and advantages of the present invention will be more readily understood from the following detailed description when read in conjunction with the appended drawing, in which:

FIG. 1 is a circuit block diagram of a VOIP network phone forwarding device of the present invention;

FIG. 2 is a circuit block diagram of a processor of a VOIP network phone forwarding device of the present invention;

FIG. 3 is a block diagram of an automatic call forwarding communication system of the present invention; and

FIG. 4 is a flowchart of an automatic call forwarding method of the present invention.

### DETAILED DESCRIPTION OF THE PREFERRED EMBODIMENTS

The present invention proposes a VOIP network phone forwarding device and the application thereof to realize an automatic call-forwarding communication system and method via this VOIP network phone forwarding device.

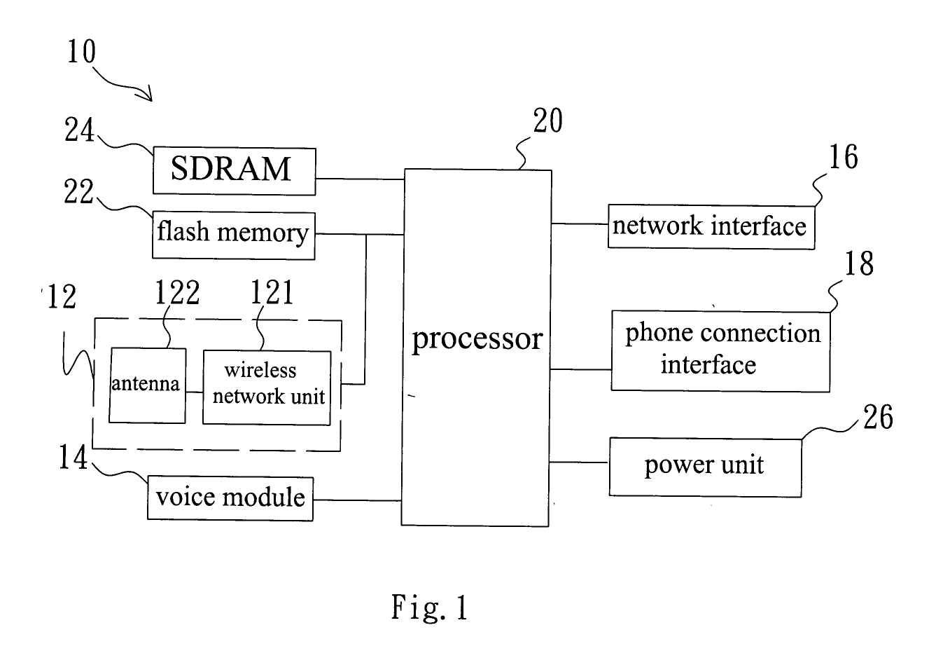

As shown in FIG. 1, a VOIP network phone forwarding device of the present invention 10 comprises a wireless network module 12, a voice module 14, a network interface 16, 1 telephone connection interface 18, a processor 20, a flash memory 22, an SDRAM 24, and a power unit 26. The processor is connected to all the other above components for controlling their actions. The flash memory 22 and the SDRAM 24 are coupled to the processor 20, and are used to store system software, parameter setting or operation data. The power unit 26 provides electric power for all the above components. The wireless network module 12 comprises a wireless network unit 121 and an antenna 122. The wireless network unit 121 is coupled to the processor 20, and the antenna 122 is coupled to the wireless network unit 121. The wireless network unit 121 conforms to IEEE 802.11 wireless communication protocol for network data transmission such as IEEE 802.11a/b/g. The antenna 122 is used to transmit and receive wireless signals. Therefore, the VOIP network phone forwarding device 10 can connect to a wireless network via the wireless network module 12. Moreover, because the wireless network unit 121 conforms to IEEE 802.11 protocol, the VOIP network phone forwarding device 10 is actually connected to a wireless local area network (WLAN) to communicate with other communication devices (e.g., wireless access point, dual-mode mobile terminal connected to the network, and so on) via the WLAN. The voice module 14 is used to provide voice service, and can be built in the processor 20 or a storage device like a storage device having a USB connector. The storage device then transmits voice signals to the processor 20 for processing via a data transmission interface coupled to the processor 20. The network interface 16 is coupled to at least one modem device such as an xDSL modem, a cable modem, a wireless AP, a HUB, or an IP sharer for connecting to the Internet. The network interface 16 is an RJ45 interface, and is connected to the modem device via at least one network line. The telephone connection interface 18 is coupled to at least one PBX, and the PBX is further coupled to at least one extension (e.g., a common desktop extension). The telephone connection interface 18 is an RJ 11 interface, and is connected to the PBX via at least a telephone line.

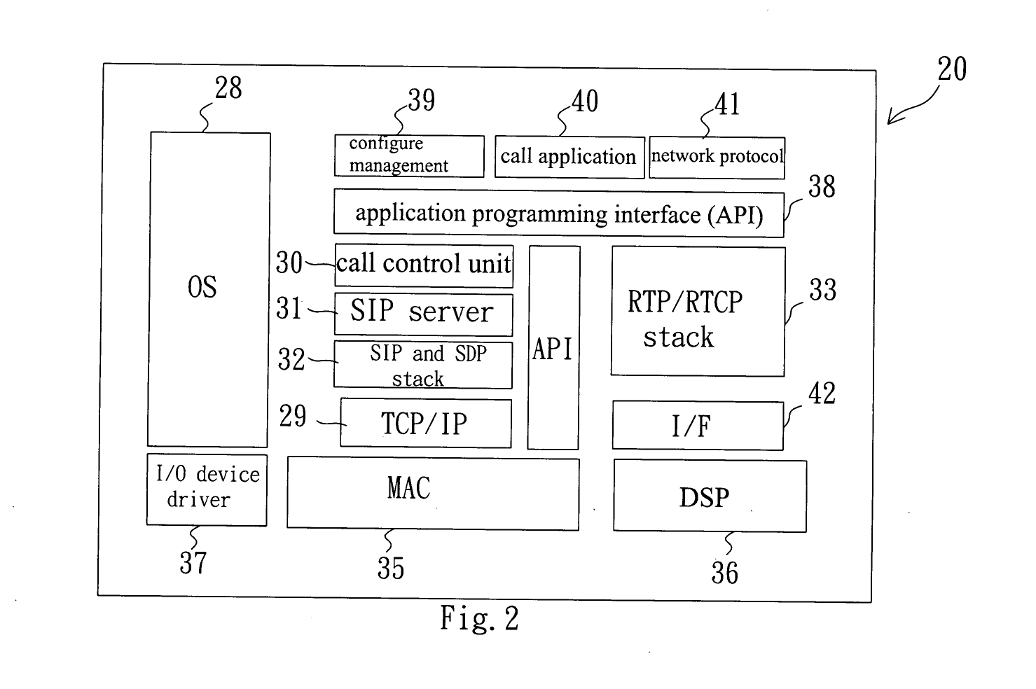

As shown in FIG. 2, the processor 20 has an operation system (OS) 28 such as Linux, a TCP/IP protocol 29 for transmitting packets to a destination, a call control unit 30, a session initiation protocol (SIP) server 31, and an SIP/SDP (session description protocol) stack 32. The SIP is a signaling protocol for managing network multimedia communication to build phone communication with at least one communicator, and is responsible for the functions of connection and disconnection of phone communication, forwarding, and identity authentication of both sides. The SDP manages to describe multimedia contents such as voice or image in a text format. The SIP is synchronous with the SDP, and transmit real-time data (e.g., real-time multimedia data such as voice or image) in the network via a RTP/RTCP stack 33. When receiving an SIP connection request from an SIP client, the SIP server 31 will transfer this request to the next SIP client, a medium access control (MAC) 35, a digital signal processing (DSP) unit 36, and an I/O device driver 37. The MAC 35 can be an Ethernet MAC for providing control such as addressing and medium access. The DSP unit 36 is used to convert analog voice format from the telephone line to digital voice format for transmission in the network. The I/O driver 37 allows mutual connection and data communication of hardware controlled by the OS 28. The processor 28 has also an application programming interface (API) 38, a configuration management 39, a call application 40, a network protocol 41, and a bus I/F (interface) 42.

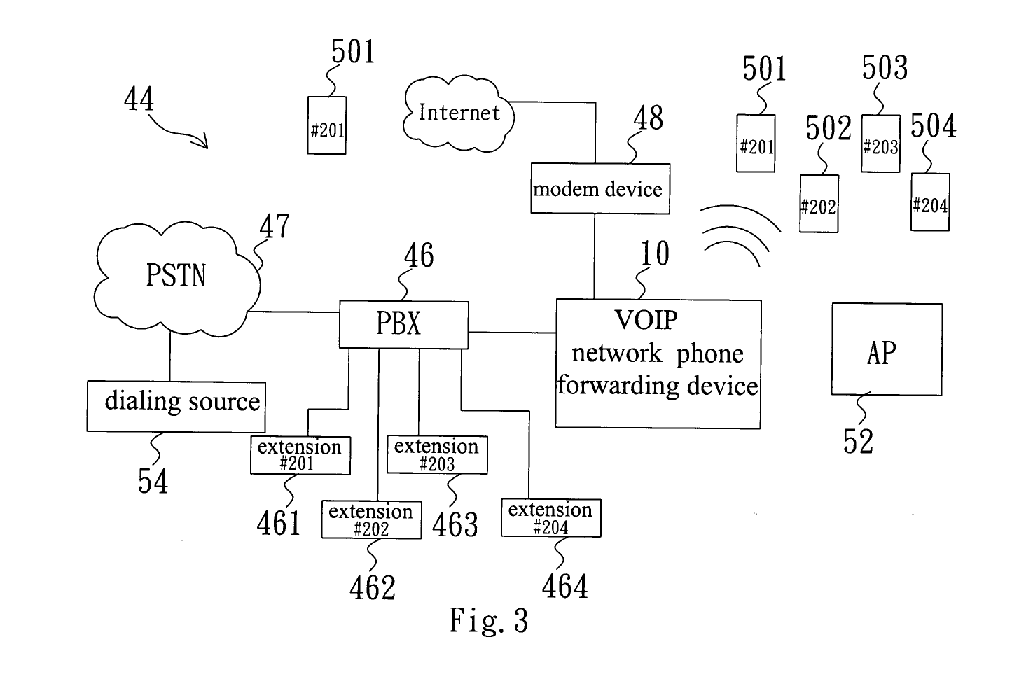

How to use the VOIP network phone forwarding device 10 to realize an automatic call-forwarding communication system will be illustrated below. In order to facilitate the illustration, please refer to the structure diagram of an automatic call-forwarding communication system shown in FIG. 3.

As shown in FIG. 3, an automatic call-forwarding communication system 44 of the present invention comprises a VOIP network phone forwarding device 10, a PBX 46, four desktop extensions 461, 462, 463, 464, a modem device 48, and four dual-mode mobile terminals 501, 502, 503, 504. The telephone connection interface 18 of the VOIP network forwarding device 10 has four RJ11 connection ports for coupling with telephone lines. The VOIP network phone forwarding device 10 has a fixed IP address. The PBX 46 is coupled to the four desktop extensions 461, 462, 463, 464 and a PSTN 47, and is coupled to the telephone connection interface 18 of the VOIP network phone forwarding device 10 via a telephone line. The VOIP network phone forwarding device 10 can connect to a WLAN through the wireless network module 12. The modem device 48 such as an XDSL modem, a cable modem, a wireless AP, a HUB, or an IP sharer is coupled to the VOIP network phone forwarding device 10 so that the VOIP network phone forwarding device 10 can connect to the Internet. The four dual-mode mobile terminals 501, 502, 503, 504 have built-in GSM and WiFi modules, and have also VOIP function. Therefore, the dual-mode mobile terminals 501-504 can connect to the WLAN in the hot spot provided by a wireless AP 52 so as to perform signal transmission with the VOIP network phone forwarding device 10. The dual-mode mobile terminals 501-504 also registers to the VOIP network phone forwarding device 10 so that the dual-mode mobile terminals 501-504 can become extended mobile terminals from the desktop extensions 461-464, i.e., the dual-mode mobile terminals 501-504 become extended extensions of the desktop extensions, respectively. When a dialing source 54 dials a phone call to a certain extension e.g., the desktop extension 461, the processor 20 of the VOIP network phone forwarding device 10 will forward this phone call to the dual-mode mobile terminal 501 via the wireless network or the Internet so that the user can answer this phone call. The dialing source 54 can come from a PSTN, a mobile communication network, or a VOIP system.

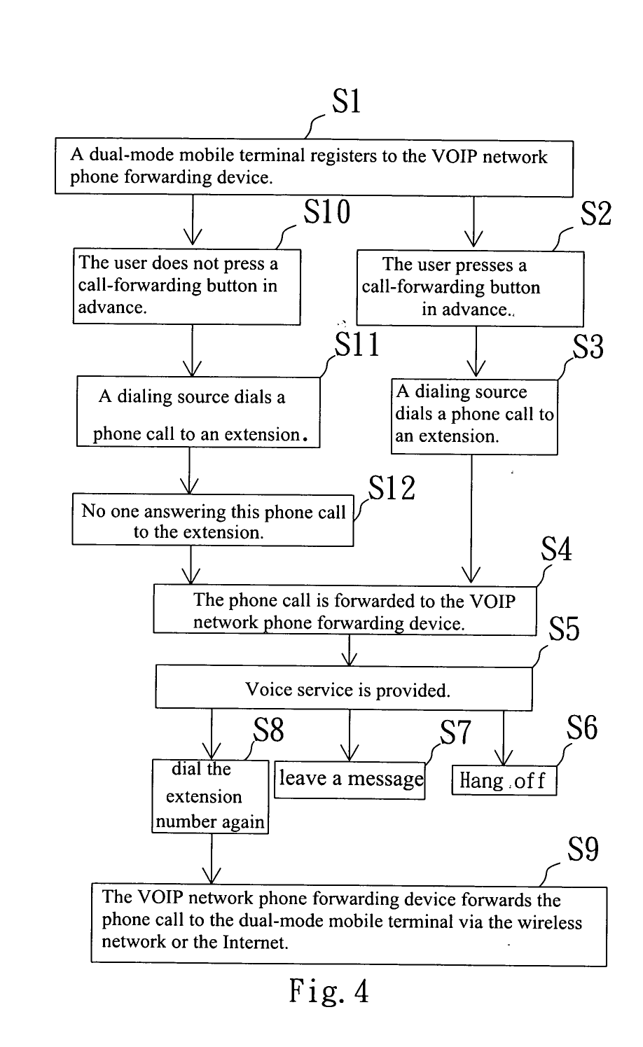

The use manner of the VOIP network phone forwarding device will be further illustrated below with reference to the flowchart diagram of the automatic call-forwarding method shown in FIG. 4. A dual-mode mobile terminal connect to a wireless network in the hot spot of a wireless AP to perform signal transmission with the VOIP network phone forwarding device, and registers to the VOIP network phone forwarding device 10 to become an extended extension of a desktop extension (Step S1). If the user is engaged and cannot be at the vicinity of the desktop extension, he can press a call-forwarding button on the VOIP network phone forwarding device in advance (Step S2). Then, when a dialing source dials a phone call to the desktop extension (Step S3), the desktop extension will forward this phone call to the VOIP network phone forwarding device (Step S4). The VOIP network phone forwarding device will then use its voice module to provide voice service for the dialing source, e.g., ‘The callee is not at the vicinity, please dial the extension number again and we will forward this phone call to the mobile terminal of the callee, or press the “#” button to leave a message, or just hang up if you don't want to leave a message’. The dialing source can then directly hang off the telephone (Step S6), or leave a message for the other side (Step S7), or dial again the extension number (Step S8). After receiving this redialed extension number, the VOIP network phone forwarding device will forward this phone call to the dual-mode mobile terminal via the WLAN or the Internet so that the user can answer this phone call (Step S9).

If the user does not set the call-forwarding button of the VOIP network phone forwarding device in advance at the beginning (Step S10) and a dialing source dials a phone call to a desktop extension (Step S11), there will be no one answering this desktop extension (Step S12). This desktop extension will still forward this phone call to the VOIP network phone forwarding device (Step S4) to provide voice service for the dialing source so that the dialing source can determine whether to forward this phone call to a dual-mode mobile terminal or not (Step S5). Subsequent steps are the same as mentioned above and thus won't be further described.

Besides, the voice messages of the above voice service are replaceable, and the dual-mode mobile terminal can also dial a phone call, and voice signals will be compressed into digital data packet for transmission in the network.

To sum up, in the environment with a wireless network or the Internet, the VOIP network phone forwarding device of the present invention can forward a phone call to a dual-mode mobile terminal to realize a mobile extension communication architecture, thereby solving the problem that a user is not at the vicinity of an extension and thus cannot answer this phone call. Moreover, the VOIP network phone forwarding device of the present invention can be used without the need of replacing conventional PBX with expensive VOIP hardware equipments like IP PBX, hence saving the cost.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A VOIP network phone forwarding device used to forward phone calls of at least one extension to at least one dual-mode mobile terminal, said dual-mode mobile terminal being able to connect to a wireless network and register to said network phone forwarding device so as to become an extended extension of said extension, said VOIP network phone forwarding device comprising:
a wireless network module coupled to said wireless network for signal transmission with said dual-mode mobile terminal;
a network interface coupled to at least one modem device to connect to the Internet;
a phone connection interface coupled to at least one PBX that is coupled to said extension;
a processor coupled to said wireless network module, said network interface and said phone connection interface, said processor forwarding a phone call to said dual-mode mobile terminal so that a user can answer the phone call when a dialing source dials the phone call to said extension; and
a power unit for providing electric power for all the above components.

2. The VOIP network phone forwarding device as claimed in claim 1 further comprising a voice module, which is coupled to said processor to provide voice service for said dialing source.

3. The VOIP network phone forwarding device as claimed in claim 2, wherein said voice module is built in said processor.

4. The VOIP network phone forwarding device as claimed in claim 2 further comprising a data transmission interface, wherein said data transmission interface is coupled to said processor, and said voice module is built in a storage device and coupled to said data transmission interface so that voice messages of said voice module are processed by said processor.

5. The VOIP network phone forwarding device as claimed in claim 1, wherein said wireless network module comprises:
a wireless network unit coupled to said processor and used to transmit network data; and
at least one antenna coupled to said wireless network unit and used to transmit and receive wireless signals.

6. The VOIP network phone forwarding device as claimed in claim 1, wherein said wireless network is a wireless LAN.

7. The VOIP network phone forwarding device as claimed in claim 5, wherein said wireless network unit conforms to IEEE 802.11 format.

8. The VOIP network phone forwarding device as claimed in claim 1, wherein said network interface and said modem device are coupled together via at least one network line.

9. The VOIP network phone forwarding device as claimed in claim 1, wherein said phone connection interface and said PBX are coupled together via at least one telephone line.

10. The VOIP network phone forwarding device as claimed in claim 1, wherein said network interface is an RJ45 interface.

11. The VOIP network phone forwarding device as claimed in claim 1, wherein said phone connection interface is an RJ11 interface.

12. The VOIP network phone forwarding device as claimed in claim 1, wherein said modem device is an xDSL modem, a cable modem, an access point, a hub, or an IP sharer.

13. The VOIP network phone forwarding device as claimed in claim 1, wherein said dual-mode mobile terminal has an GSM module and a WiFi module built therein.

14. The VOIP network phone forwarding device as claimed in claim 1, wherein said extension is further coupled to a PSTN.

15. The VOIP network phone forwarding device as claimed in claim 1, wherein said dialing source comes from a PSTN, a mobile communication network, or a VOIP system.

16. The VOIP network phone forwarding device as claimed in claim 1, wherein said processor has a SIP server and a SIP/SDP stack built therein.

17. An automatic call-forwarding communication system comprising:
a VOIP network phone forwarding device connected to a wireless network;
a PBX coupled to said VOIP network phone forwarding device and a PSTN;
at least one modem device coupled to said VOIP network phone forwarding device for connecting to the Internet;
at least one extension coupled to said PBX; and
at least one dual-mode mobile terminal capable of connecting to said wireless network for signal transmission with said VOIP network phone forwarding device in a hot-spot environment and then registering to said VOIP network phone forwarding device to become an extended extension of said extension, said VOIP network phone forwarding device forwarding a phone call to said dual-mode mobile terminal via said wireless network or the Internet so that a user can answer the phone call when a dialing source dials the phone call to said extension.

18. The automatic call-forwarding communication system as claimed in claim 17, wherein said VOIP network phone forwarding device comprises:
a wireless network module connected to said wireless network;
a network interface coupled to said modem device to connect to the Internet;
a phone connection interface coupled to said PBX;
a processor coupled to said wireless network module, said network interface and said phone connection interface, said processor forwarding said phone call to said dual-mode mobile terminal via said wireless network or the Internet so that said user can answer the phone call when said dialing source dials the phone call to said extension; and
a power unit for providing electric power for all the above components.

19. The automatic call-forwarding communication system as claimed in claim 18, wherein said VOIP network phone forwarding device further comprises a voice module, which is coupled to said processor to provide voice service for said dialing source.

20. The automatic call-forwarding communication system as claimed in claim 19, wherein said voice module is built in said processor.

21. The automatic call-forwarding communication system as claimed in claim 19, wherein said VOIP network phone forwarding device further comprises a data transmission interface coupled to said processor, and said voice module is built in a storage device, and said storage device is coupled to said data transmission interface so that voice messages of said voice module are processed by said processor.

22. The automatic call-forwarding communication system as claimed in claim 18, wherein said wireless network module comprises:
a wireless network unit coupled to said processor and used to transmit network data; and
at least one antenna coupled to said wireless network unit and used to transmit and receive wireless signals.

23. The automatic call-forwarding communication system as claimed in claim 17, wherein said wireless network is a wireless LAN.

24. The automatic call-forwarding communication system as claimed in claim 22, wherein said wireless network unit conforms to IEEE 802.11 format.

25. The automatic call-forwarding communication system as claimed in claim 18, wherein said network interface and said modem device are coupled together via at least one network line.

26. The automatic call-forwarding communication system as claimed in claim 18, wherein said phone connection interface and said PBX are coupled together via at least one telephone line.

27. The automatic call-forwarding communication system as claimed in claim 18, wherein said network interface is an RJ45 interface.

28. The automatic call-forwarding communication system as claimed in claim 18, wherein said phone connection interface is an RJ11 interface.

29. The automatic call-forwarding communication system as claimed in claim 17, wherein said modem device is an XDSL modem, a cable modem, an access point, a hub, or an IP sharer.

30. The automatic call-forwarding communication system as claimed in claim 17, wherein said dual-mode mobile terminal has an GSM module and a WiFi module built therein.

31. The automatic call-forwarding communication system as claimed in claim 17, wherein said dialing source comes from a PSTN, a mobile communication network, or a VOIP system.

32. The automatic call-forwarding communication system as claimed in claim 18, wherein said processor has a SIP server and a SIP/SDP stack built therein.

33. An automatic call-forwarding method comprising the steps of:
coupling a VOIP network phone forwarding device to at least one PBX coupled to at least one extension, connecting said VOIP network phone forwarding device to a wireless network, and coupling said VOIP network phone forwarding device to at least one modem device to connect to the Internet;
providing at least one dual-mode mobile terminal capable of connecting to said wireless network for signal transmission with said VOIP network phone forwarding device in a hot-spot environment and then registering to said VOIP network phone forwarding device to become an extended extension of said extension; and
using said VOIP network phone forwarding device to forward a phone call to said dual-mode mobile terminal via said wireless network or the Internet so that a user can answer the phone call when a dialing source dials the phone call to said extension.

34. The automatic call-forwarding method as claimed in claim 33, wherein said VOIP network phone forwarding device will forward the phone call when said dialing source dials the phone call to said extension and there is no one answering the phone call.

35. The automatic call-forwarding method as claimed in claim 33 further comprising the step of pressing a call-forwarding button on said VOIP network phone forwarding device so that said VOIP network phone forwarding device will forward the phone call when said dialing source dials the phone call to said extension.
